(19) United States
(12) Patent Application Publication
(10) Pub. No.: US 2026/0307298 A1
(43) Pub. Date: Oct. 8, 2026

(54) MOULD FITTED WITH AN IMPROVED PUSHER DEVICE

(71) Applicant: SAFRAN, PARIS (FR)

(72) Inventors: Thomas Bernd Paulo VIASSONE, MOISSY CRAMAYEL (FR); Thierry Patrick CHAUVIN, MOISSY CRAMAYEL (FR)

(21) Appl. No.: 19/483,332

(22) PCT Filed: May 6, 2024
(86) PCT No.: PCT/FR2024/050593

§ 371 Date: Nov. 11, 2025

(30) Foreign Application Priority Data
May 12, 2023 (FR) FR2304737

(51) Int. Cl. B29C 33/20; B29C 70/48

(52) U.S. Cl. CPC B29C 33/20; B29C 70/48

(57) ABSTRACT

The mould includes a base, a removable shim, a belt, and a pusher device capable of moving the base and the belt away from one another automatically. The pusher device includes a pusher bearing vertically on the base, a hook pin movable vertically between an upper position at a distance above the pusher and a lower position bearing on the pusher, and a locking assembly which is secured to the belt and locks the hook pin in the lower position. The pusher includes a spring which is compressed when the hook pin is in the lower position, this spring then exerting an upward pushing force on the hook pin. The belt has a through-opening in which the hook pin is housed, extending therethrough, an upper portion of the hook pin extending above the belt when the pin is in the upper position.

### TECHNICAL FIELD OF THE INVENTION

The technical field of the invention is that of moulding, and in particular resin transfer moulding, using a mould comprising a base, a cover and at least one intermediate wedge located between the base and the cover.

The present invention relates to a pusher device able to automatically move the base and the belt apart from each other when the pressure holding the base and the cover against each other is released.

### TECHNOLOGICAL BACKGROUND OF THE INVENTION

Usually, during resin transfer moulding, the material of the moulded piece has a coefficient of thermal expansion that is different from the coefficient of thermal expansion of the material of the mould, which generates undesirable stresses in the moulded piece during cooling thereof. These stresses are likely to damage the piece and make its stripping difficult, as the moulded piece may become stuck in the mould due to clamping.

In order to overcome these drawbacks, document FR 3001653 A1 in the name of the applicant and represented in FIG. 1 and FIG. 2 discloses a mould 1′ including at least one removable wedge 3 located between a base 2 and a belt 5 which also acts as a cover for the mould 1′. Each wedge 3 has a tilted face 4 that slides along an additional tilted face 6 provided on the belt 5 when the mould 1′ is open. The mould 1′ also comprises a pusher device 7′ that automatically moves the base 2 and the belt 5 apart from each other when the pressure that holds the base 2 and the belt 5 against each other during moulding is released, allowing each wedge 3 to slide upwards and laterally away from the moulded piece 8, to prevent the wedges 3 from exerting stresses to the moulded piece 8.

When no pressure is exerted to hold the base and the belt against each other, the pusher device of document FR 3001653 A1 holds these two parts in a moved-apart position and the mould is therefore in a partially open position. Yet, it may be desired that the mould be in the closed position when it is in the rest position, while still incorporating a pusher device that automatically moves the base and the belt apart from each other at the end of moulding, when the pressure holding the base and the belt against each other is released.

This makes it possible, especially, to manually and delicately position the wedges and the belt on the reinforcement to be impregnated with resin before closing the mould, while ensuring that the reinforcement is correctly positioned in the base, without being creased, folded and/or stuck by the wedges. This also ensures that the reinforcement is correctly arranged and placed when it consists of several layers that have to be carefully positioned relative to each other and pressed against each other before moulding.

The purpose of the invention is therefore to provide a modified pusher device that automatically moves the base and the belt apart from each other when the pressure holding them against each other is released, but which does not move these pieces apart before said pressure has been exerted, that is, which allows the mould to remain in the closed position by gravity when the base and the belt are laid against each other before pressure is exerted to the mould to hold these pieces pressed against each other during resin injection.

### SUMMARY OF THE INVENTION

The invention provides a solution to the previously discussed problems by providing a pusher device comprising two pieces which are initially distant from each other when the mould is closed but no pressure has yet been applied to hold the base and the belt against each other, and which are mutually locked after this pressure has been exerted, so that when the pressure is released, the base and the cover are automatically moved apart from each other by the pusher device.

One aspect of the invention relates to a mould comprising:
a base,
a removable wedge,
a belt,
a pusher device able to automatically move the base and the belt apart from each other, where
in the closed position of the mould, the wedge vertically bears on the base, the belt vertically bears on said wedge and on the base, the wedge laterally bears against the belt, and the wedge, the base and the belt delimit a hollow moulding volume,
wherein the pusher device comprises:
a first part, referred to as a pusher, vertically bearing on the base,
a second part, referred to as a hook pin, vertically movable between a high position in which the hook pin is at a distance above the pusher and a low position in which the hook pin bears on the pusher,
a locking set, integral with the belt, which locks the hook pin in the low position, and
the pusher includes a spring which is compressed when the hook pin is in the low position, this spring then exerting a pushing force on the hook pin in order to move it to the high position, and
the belt has a through hole through which the hook pin is housed, with an upper part of the hook pin extending above the belt when the hook pin is in the high position.

Further to the characteristics just discussed in the preceding paragraph, the mould according to one aspect of the invention may have one or more complementary characteristics from among the following, considered individually or according to any technically possible combinations:
the hook pin comprises a vertical shaft extending along an axis Y-Y′ substantially parallel to a stripping axis and having a locking surface perpendicular to the axis Y-Y′, the locking set comprises at least one movable piece that can be moved between an engagement position and a disengagement position, the locking set comprises a spring which pushes the movable piece into the locking position, when the movable piece is in the engagement position, the locking surface of the hook pin bears against a lower face of the movable piece of the locking set, and when the movable piece is in the disengagement position, it is not in contact with the locking surface.
the outer side face of the vertical shaft or an outer face of the movable piece of the locking set has a tilted ramp forming a sliding ramp between the vertical shaft and the movable piece, and the hook pin is vertically movable in an intermediate position located between the high position and the low position, and in which the tilted ramp moves the movable piece laterally from its unlocking position to its locking position.
the tilted ramp of the vertical shaft is in the form of a conical or frustoconical part tapering downwards and provided at the lower end of the vertical shaft, and the locking surface of the hook pin is an upper face of the conical or frustoconical part.
the locking set comprises two movable pieces facing each other on either side of the hook pin and each pushed closer to said hook pin by a spring.
the pusher comprises a lower bearing piece, an upper bearing piece that is vertically movable, and a spring that is elastically deformable between a rest condition and a compressed condition in which it exerts a pushing force between the two bearing pieces.
the lower bearing piece comprises a tubular part having a hollow volume in its lower part, the pusher comprises a vertical rod attached to the upper bearing piece and slidably mounted into the tubular part, and the height of the hollow volume is greater than the distance travelled by the vertical rod when the spring switches from the rest condition to the compressed condition.
the tubular part of the lower bearing piece has a narrowing in its upper part, and the vertical rod has a shoulder in its lower part, this shoulder being pressed in abutment against a lower face of the narrowing of the lower bearing piece by the pushing force of the spring.
the upper part of the vertical rod has a threaded part, the upper bearing piece comprises a threaded port, and the threaded part of the vertical rod is screwed into the threaded port of the upper bearing piece.
the mould comprises a cover located above the belt, which cover has a through hole that communicates with the through hole of the belt, the hook pin being housed in the through hole of the belt and in the through hole of the cover, and the upper part of the hook pin extending above the cover when the hook pin is in the high position.
the base has a hollow-shaped housing in which the lower bearing piece of the pusher is at least partially housed.
the wedge has a tilted face, the belt has a tilted face, and in the closed position of the mould, the tilted face of the wedge laterally bears on the tilted face of the belt.

Another aspect of the invention relates to a moulding method using a mould as described previously, comprising the following steps of:
closing the mould;
applying pressure to the mould and the pusher device, and switching the pusher device from an unlocked condition to a locked condition;
releasing pressure to the mould and the pusher device, and automatically moving the base and the belt away from each other by the pusher device; and
opening the mould.

According to one aspect of the invention, the moulding method is a resin transfer moulding method.

By virtue of this invention, after the mould has been closed and before any pressure has been exerted thereto, the belt freely rests against the base and each wedge, and the hook pin is in the high position, which especially makes it possible to ensure that the reinforcement to be impregnated with resin is correctly positioned and duly kept stationary. After pressure is applied to the mould, for example by a press, the upper part of the hook pin is forced downwards, which moves the hook pin to a low position, where it is lockingly engaged by the locking set and compresses the spring of the pusher device. When pressure to the mould is released, the spring of the pusher device automatically pushes the hook pin back upwards, which in turn lifts the belt via the locking set, advantageously allowing each wedge to slide upwards and laterally away from the moulded piece. Thus, the mould of the invention does not generate undesirable stresses in the piece during moulding, and stripping of the finished piece is further facilitated.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a schematic side cross-section view of a mould according to prior art in a partially open position in the absence of pressure to hold the mould closed.

FIG. 2 is a view similar to FIG. 1 where the mould is in the closed position with a pressure force exerted to the mould.

FIG. 3 is an overall view of a pusher device according to the invention.

FIG. 4 is a cross-section view of a pusher device of the invention in the sectional plane IV-IV represented in FIG. 3.

FIG. 5 is a schematic side cross-section view of a mould according to the invention in the closed position but without any pressure force being exerted to the mould.

FIG. 6 is a view similar to FIG. 5, where the mould is in the closed position with a pressure force exerted to the mould, the pusher device being in the locking position.

FIG. 7 is a view similar to FIG. 5 and FIG. 6, where the mould is in a partially open position in the absence of pressure to hold the mould closed.

FIG. 8 and FIG. 9 are simplified schematic views illustrating alternatives of the pusher device according to the invention.

FIG. 10 and FIG. 11 are schematic top cross-section views of a pair of half-rings of the pusher device in the closed and open positions.

FIG. 12 is a schematic top cross-section view of an alternative of the pair of half-rings shown in FIG. 10.

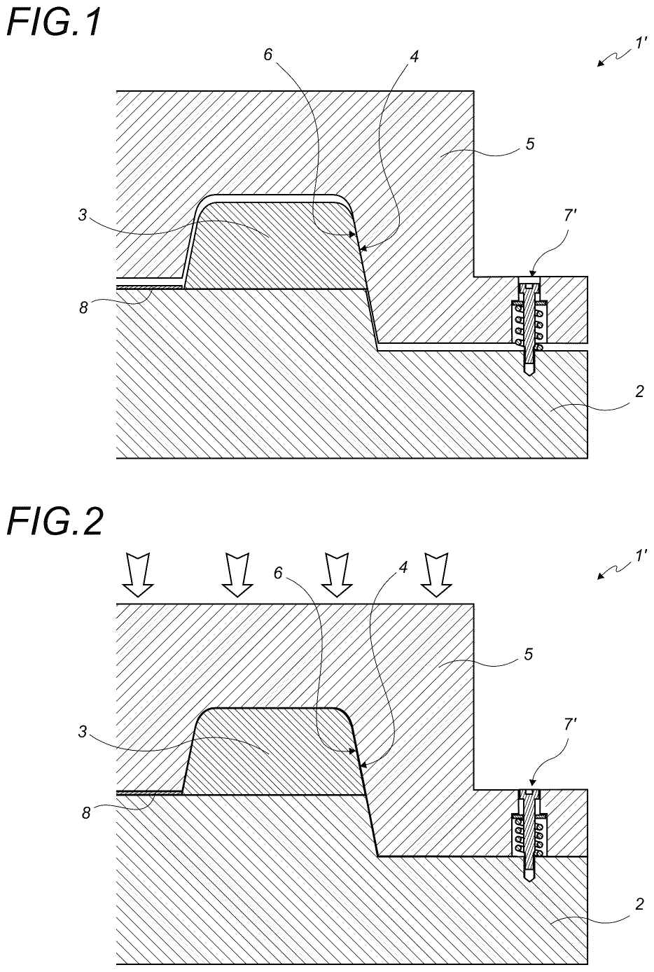

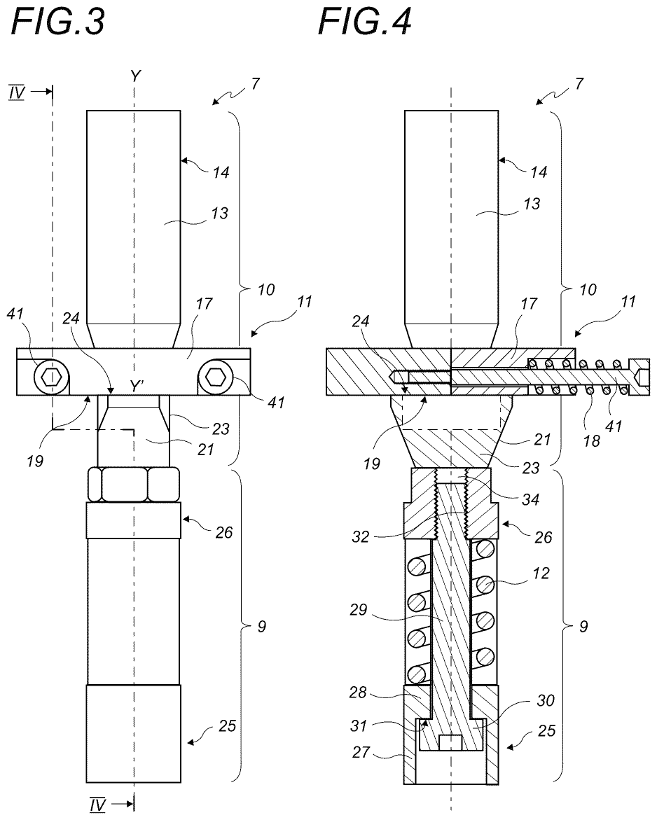

### DETAILED DESCRIPTION

The figures are set forth by way of indicating and in no way limiting purposes of the invention.

By convention, in this application, when referring to the mould according to the invention, by upper, lower, above and under, it is referred to the mould as represented in the drawings. Likewise, by vertical, it is referred to a direction along an axis extending perpendicularly to the main plane in which the base of the mould extends. In the figures, the axis Y-Y′ is vertical and substantially corresponds to a stripping axis, that is, an axis along which the different pieces of the mould are usually away from each other when it is open.

The mould 1 according to the invention includes at least one removable wedge 3 located between a base 2 and a belt 5, the purpose of which is to hold the wedges 3 in position in the mould 1 when it is closed. It may also comprise a cover 15 provided above the belt 5.

When the mould 1 is in the closed position, each wedge 3 is in contact with the base 2. The belt 5, the wedge 3 and the base 2 then delimit a hollow moulding volume 38 where a reinforcement can be impregnated with resin to form a moulded piece 8.

At least one wedge 3 is provided to be partially in contact with the moulded piece 8. This wedge preferably has a tilted face 4 which preferably slides along an additional tilted face 6 provided on the belt 5 when opening the mould 1. When the mould 1 is closed, the tilted face 4 of each wedge 3 may also be located as an extension from a tilted face 39 of the base 2.

The mould 1 according to the invention also comprises a pusher device 7 including a pusher 9, a hook pin 10 and a locking set 11.

The hook pin 10 is vertically movable between a high position in which it is at a distance from the pusher 9 and a low position in which it bears on the pusher 9. It comprises a vertical shaft 13 extending along an axis Y-Y′ and has a horizontal locking surface 16.

The belt 5 has a through hole 34 through which the hook pin 10 is housed, with an upper part of the hook pin 10 extending above the belt 5 when the hook pin 10 is in the high position.

When the mould 1 comprises a cover 15 located above the belt 5, this cover 15 has a through hole 35 that communicates with the through hole 34 of the belt 5. The hook pin 10 is housed in the through hole 34 of the belt 5 and in the through hole 35 of the cover 15, and the upper part of the hook pin 10 extends above the cover 15 when the hook pin 10 is in the high position.

The locking set 11, integral with the belt 5, is provided to lock the hook pin 10 when it is in the low position so as to prevent it from rising without also lifting the belt 5. The locking set 11 is preferably mounted into a housing 40 horizontally extending in the belt 5. It comprises at least one movable piece 17 that can be moved between an engagement position and a disengagement position. In the engagement position, the locking surface 16 of the hook pin 10 preferably bears against a lower face 19 of the movable piece 17. In the disengagement position, the movable piece 17 is not in contact with the locking surface 16. It can then be at a distance from the vertical shaft 13. The locking set 11 comprises a spring 18 which tends to push the movable piece 17 into the locking position.

An outer side face 14 of the vertical shaft 13 or an outer face 20 of the movable piece 17 of the locking set 11 preferably has a tilted ramp 21, 22 forming a sliding ramp between the vertical shaft 13 and the movable piece 17, provided so that when the hook pin 10 is in an intermediate position located between the high position and the low position, the tilted ramp 21, 22 moves the movable piece 17 laterally from its unlocking position to its locking position by the sliding contact of the vertical shaft 13 against the movable piece 17 of the locking set 11.

The tilted ramp 21 of the vertical shaft 13 is preferably in the form of a conical or frustoconical part 23 tapering downwards and provided at the lower end of the vertical shaft 13, and the locking surface 16 of the hook pin 10 is an upper face 24 of the conical or frustoconical part 23.

The movable piece 17 of the locking set 11 preferably has a tilted ramp 22, the low part of which is directed towards the vertical shaft 13.

Two alternatives are represented in FIG. 8-FIG. 9, where either the vertical shaft 13 has a ramp 21 or the movable piece 17 has a ramp 22.

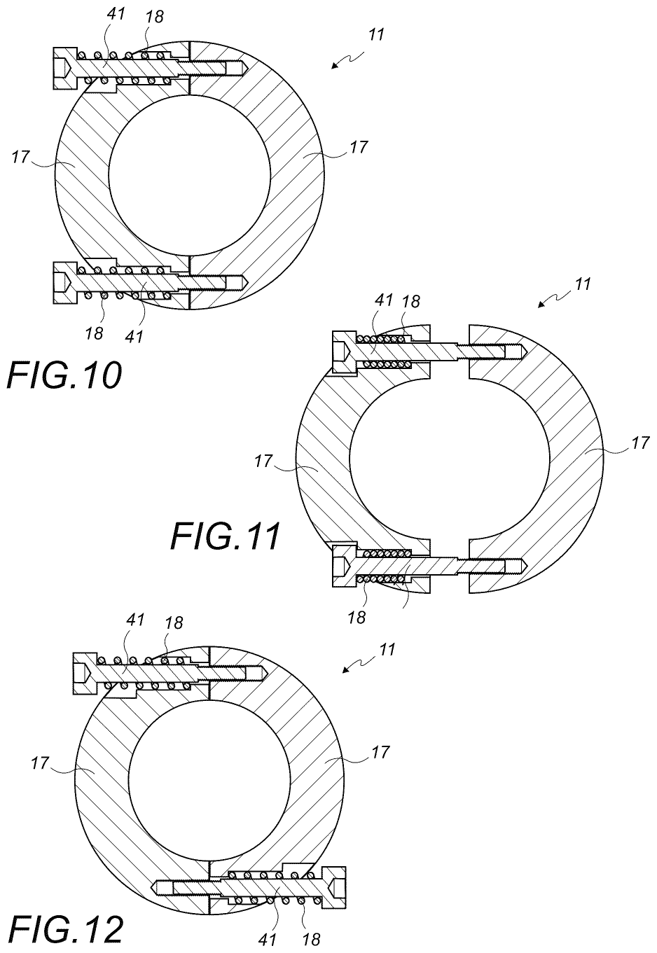

As represented by way of example in FIG. 10-FIG. 12, the locking set 11 preferably comprises two movable pieces 17, for example in the form of half-rings, facing each other on either side of the hook pin 10 to form a ring, and each pushed closer to said hook pin 10 by a spring 18, the mutual movement of the two movable pieces 17 being preferably guided by a pair of screws 41 screwed into one of the two movable pieces 17 and slidably mounted into the other movable piece 17. The two movable pieces 17 are represented in contact in FIG. 10-FIG. 12, and in a moved-apart position in FIG. 11.

It will be noted that a minimum force is applied by the springs 18 to hold the movable pieces 17 in contact. The travel of said springs 18 allows the conical or frustoconical part 23 of the hook pin 10 to pass through and then return to its locked shape subsequently. The inner diameter of the ring formed by the movable pieces 17 in contact is greater than the diameter of the vertical shaft 13.

The pusher 9 preferably comprises a lower bearing piece 25, an upper bearing piece 26 that is vertically movable, and a spring 12 that is elastically deformable between a rest condition and a compressed condition in which it exerts a pushing force between the two bearing pieces 25, 26. The pusher 9 vertically bears on the base 2, preferably through its lower bearing piece 25.

The lower bearing piece 25 preferably comprises a tubular part 27 having a hollow volume 37 in its lower part, the pusher 9 comprises a vertical rod 29 attached to the upper bearing piece 26 and slidably mounted into the tubular part 27, and the height of the hollow volume 37 allows a clearance of the vertical rod 29 when the spring 12 switches from its rest condition to its compressed condition.

The tubular part 27 of the lower bearing piece 25 preferably has a narrowing 28 in its upper part, and the vertical rod 29 has a shoulder 30 in its lower part, this shoulder 30 being pressed in abutment against a lower face 31 of the narrowing 28 of the lower bearing piece 25 by the pushing force of the spring 12.

Preferably, the upper part of the vertical rod 29 has a threaded part 32, the upper bearing piece 26 comprises a threaded port 33, and the threaded part 32 of the vertical rod 29 is screwed into the threaded port 33 of the upper bearing piece 26, which makes it possible to adjust the vertical position of the upper bearing piece 26 relative to the vertical rod 29.

The lower bearing piece 25 may directly bear on the base 2 or be at least partially housed in a hollow-shaped housing 36 in the base 2.

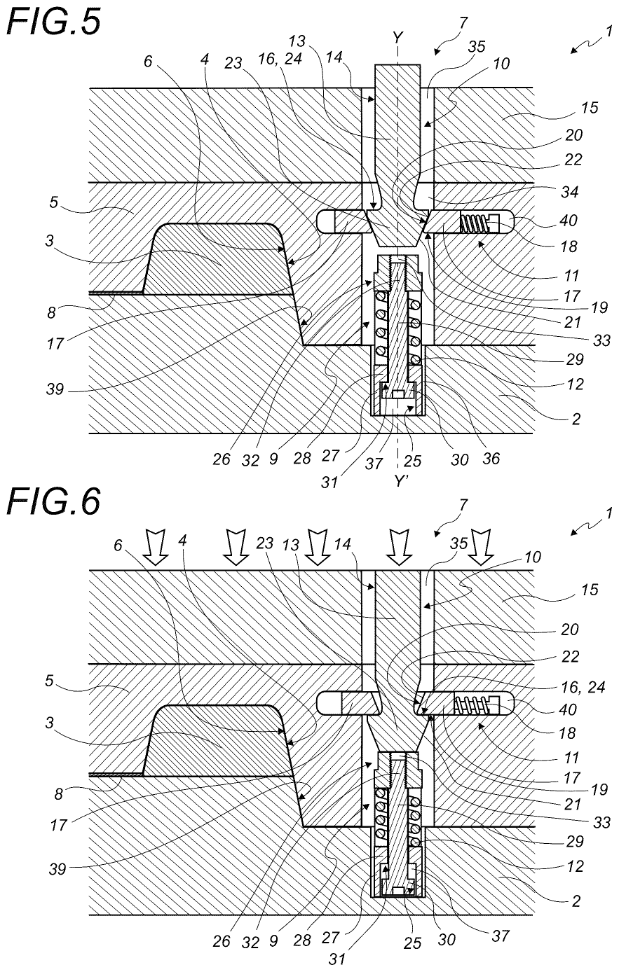

The operation of the pusher device 7 will now be explained in relation to FIG. 5-FIG. 7.

In FIG. 5, the mould is in the closed position, with no pressure being exerted thereto. The hook pin 10 is in the high position, with its upper part protruding upwards outside the mould 1. It is located at a distance from the pusher. Although this is not necessarily required, it is represented in contact with the locking set 11.

Pressure is then applied to the top of the mould 1, for example by a press, to hold it closed during resin injection. This pressure is also exerted to the protruding upper part of the hook pin 10, which then moves from its high position to its low position, moving the movable pieces 17 of the locking set 11 apart at the same time and pressing on the pusher 9 to lower its upper bearing piece 26 and compress its spring 12.

In the low position of the hook pin 10 (see FIG. 6), the lower face 19 of the movable pieces 17 of the locking set 11 bears against the locking surface 16 of the hook pin 10 to lock it in the low position.

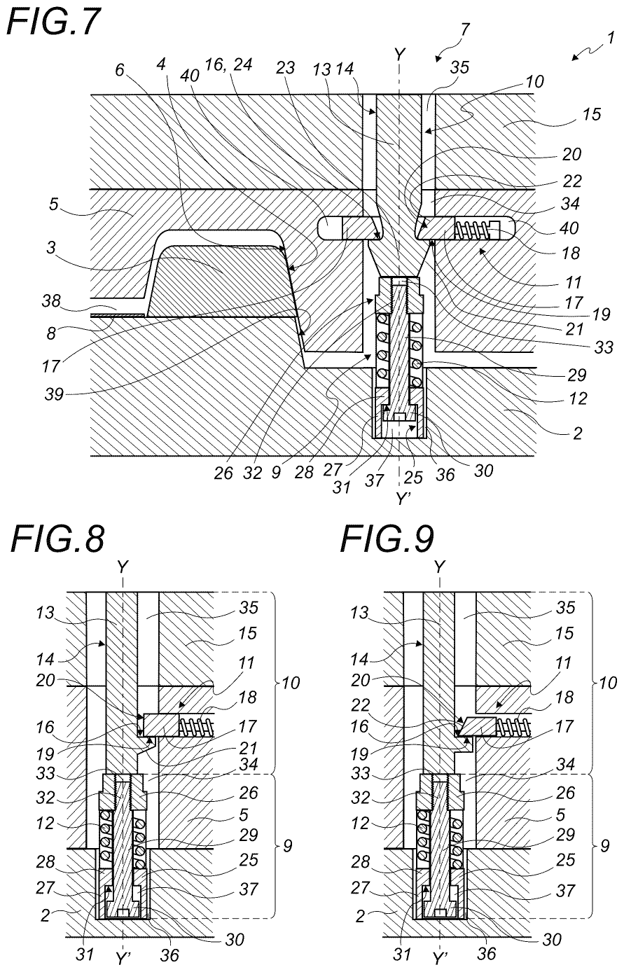

When the pressure applied to the top of the mould 1 is released (see FIG. 7), the hook pin 10 rises, pushed by the compressed spring 12 of the pusher 9. As it is lockingly engaged with the locking set 11, the hook pin 10 also tends to move the locking set 11 upwards. As the latter is integral with the belt 5, the belt is therefore moved upwards, as well as the cover 15 if present.

Moving the base 2 and the belt 5 apart from each other by the pusher device 7 is automatically performed, for example by a distance in the order of a few millimetres, when the pressure applied to the mould is released. If necessary, this preferably frees space allowing each wedge 3 to slide upwards along the tilted contact face 6 of the belt 5 and to laterally slide on the base 2 away from the moulded piece 8.

The invention also relates to a moulding method, preferably a resin transfer moulding method, using a mould 1 according to the invention, and comprising the following steps of:
closing the mould 1;
applying pressure to the mould 1 and the pusher device 7, and switching the pusher device 7 from the unlocked condition to the locked condition;
releasing the pressure to the mould 1 and the pusher device 7, and automatically moving the base 2 and the belt 5 away from each other by the pusher device 7; and
opening the mould 1.

The method for unlocking the pusher device 7 depends on the design of the locking set 11. It is preferably based on the extraction of the hook pin from below when the mould is opened, with the vertical shaft 13 passing through the ring formed by the movable pieces 17.

According to one alternative of the invention, it is possible to unlock the pusher device by moving the movable pieces 17 away from the hook pin 10. This movement can be achieved by a magnetic or mechanical device, not represented. Unlocking the pusher device 7 can, for example, be achieved by inserting a hollow tube around the vertical shaft 13 so as to bear on the tilted ramp 22 of each movable piece 17 and to temporarily move them apart from the hook pin 10, allowing it to rise to its high position.

Unless otherwise specified, a same element appearing in different figures has a single reference.

1. A mould comprising:
a base,
a removable wedge,
a belt,
a pusher device configured to automatically move the base and the belt apart from each other, where
in a closed position of the mould, the removable wedge vertically bears on the base the belt vertically bears on said removable wedge and on the base, the removable wedge laterally bears against the belt and the removable wedge, the base and the belt delimit a hollow moulding volume,
wherein the pusher device comprises:
a first part, forming a pusher, vertically bearing on the base,
a second part, forming a hook pin, vertically movable between a high position in which the hook pin is at a distance above the pusher and a low position in which the hook pin bears on the pusher,
a locking set, integral with the belt, which locks the hook pin in the low position, wherein
the pusher includes a spring which is compressed when the hook pin is in the low position, said spring spring then exerting a pushing force on the hook pin to move it to the high position, and
the belt has a through hole through which the hook pin is housed, with an upper part of the hook pin extending above the belt when the hook pin is in the high position.

2. The mould according to claim 1, wherein:
the hook pin comprises a vertical shaft extending along an axis Y-Y′ substantially parallel to a stripping axis and having a locking surface perpendicular to the axis Y-Y′,
the locking set comprises at least one movable piece that is movable between an engagement position and a disengagement position,
the locking set comprises a spring which pushes the movable piece into the locking position,
when the movable piece is in the engagement position, the locking surface of the hook pin bears against a lower face of the movable piece of the locking set, and
when the movable piece is in the disengagement position, it the movable piece is not in contact with the locking surface.

3. The mould according to claim 2, wherein:
an outer side face of the vertical shaft or an outer face of the movable piece of the locking set has a tilted ramp, forming a sliding ramp between the vertical shaft and the movable piece, and
the hook pin is vertically movable in an intermediate position located between the high position and the low position, and in which the tilted ramp, moves the movable piece laterally from its unlocking position to its locking position.

4. The mould according to claim 3, wherein:
the tilted ramp of the vertical shaft is in the form of a conical or frustoconical surface tapering downwards and provided at the lower end of the vertical shaft, and
the locking surface of the hook pin is an upper face of the conical or frustoconical part.

5. The mould according to claim 1, wherein the locking set comprises two movable pieces facing each other on either side of the hook pin and each pushed closer to said hook pin by a spring.

6. The mould according to claim 1, wherein the pusher comprises a lower bearing piece, an upper bearing piece that is vertically movable, and a spring that is elastically deformable between a rest condition and a compressed condition in which it exerts a pushing force between the two bearing pieces

7. The mould according to claim 6, wherein the base has a hollow-shaped housing in which the lower bearing piece of the pusher is at least partially housed.

8. The mould according to claim 1, wherein the mould comprises a cover located above the belt which cover has a through hole that communicates with the through hole of the belt, the hook pin being housed in the through hole of the belt and in the through hole of the cover, and the upper part of the hook pin extending above the cover when the hook pin is in the high position.

9. A moulding method using a mould according to claim 1 comprising:
closing the mould
applying pressure to the mould and the pusher device and switching said pusher device from an unlocked condition to a locked condition;
releasing the pressure to the mould and the pusher device, and automatically moving the base and the belt away from each other by the pusher device; and
opening the mould.

10. The moulding method according to claim 9, wherein the moulding method is a resin transfer moulding method.
